(19) United States
(12) Patent Application Publication
(10) Pub. No.: US 2009/0059288 A1
(43) Pub. Date: Mar. 5, 2009

(54) IMAGE COMMUNICATION SYSTEM AND IMAGE COMMUNICATION APPARATUS

(75) Inventor: Hitoshi Mitsui, Nara (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 12/201,378

(22) Filed: Aug. 29, 2008

(30) Foreign Application Priority Data
Aug. 31, 2007 (JP) 2007-225990

(51) Int. Cl. G06F 3/12

(52) U.S. Cl. 358/1.15

(57) ABSTRACT

An image communication apparatus notifies a client apparatus of a URI of an image to be transmitted by an electronic mail. The client apparatus accesses to the URI of the image. The image communication apparatus requests input of a password from the client apparatus. The client apparatus determines a password and transmits it to the image communication apparatus. The image communication apparatus encrypts the image based on the acquired password and transmits it. The client apparatus decrypts the encrypted image based on the determined password.

By providing a password necessary for encryption of an image to be transmitted to the image communication apparatus, convenience for a user of the client apparatus can be enhanced.

### BACKGROUND OF THE INVENTION

1. Field of the Invention

The present invention relates to an image communication system for transmitting an image from an image communication apparatus to a client apparatus through a network.

2. Description of the Related Art

In an image communication system wherein an image communication apparatus performs transmission/reception of an image with a client apparatus through a network such as an internet, generally, the image communication apparatus functions as a server, and when the client apparatus accesses to the image communication apparatus using a web browser, the client apparatus can browse web pages in the image communication apparatus.

Here, when the image communication apparatus transmits an image to the client apparatus, as described in Japanese Patent Laid-Open No. 2002-132682, the image communication apparatus firstly sends an electronic mail to the client apparatus. The electronic mail includes a URL and a password for the image. The client apparatus which has received it accesses to the URL using a web browser to display the image.

As described above, a password which is necessary for obtaining an image and a password which is used to encrypt an image are provided from the image communication apparatus. Thus, when a user loses or forgets the password, the password can not be created in the client apparatus. As a result, it is made impossible to access to the image communication apparatus or to decrypt an encrypted image, thus the image can not be obtained.

In view of the above-mentioned circumstances, it is an object of the present invention to provide an image communication system wherein a password which is necessary for encryption and the like is provided from the client apparatus side so that an image can be obtained reliably and securely.

### SUMMARY OF THE INVENTION

The present invention provides an image communication system in which an image communication apparatus transmits an image to a client apparatus through a network, wherein the image communication apparatus transmits a URI of the image to be transmitted by an electronic mail to the client apparatus, the client apparatus provides the image communication apparatus with specific information for encryption, and the image communication apparatus encrypts the image based on the specific information and transmits an encrypted image.

The image communication apparatus encrypts the image by the specific information provided from the client apparatus. Hence, a user of the client apparatus is able to provide specific information which is easily managed and convenience for the user is enhanced.

The image communication apparatus comprises a mail creation section for creating an electronic mail in which a URI of an image to be transmitted is described, an acquiring section for acquiring specific information from the client apparatus performing access to the URI, an image processing section for encrypting the image based on the acquired specific information, and a communication section for performing communication with the client apparatus.

When there is an image to be transmitted to the client apparatus, the mail creation section creates an electronic mail to be transmitted to the client apparatus. The URI of the image is inserted into the electronic mail. The communication section transmits the electronic mail to the client apparatus. The client apparatus which has received the electronic mail accesses to the URI of the image. The acquiring section requests input of specific information from the client apparatus depending on access from the client apparatus. In response to the request, the client apparatus transmits arbitrarily determined specific information to the image communication apparatus. The image communication apparatus generates an encryption key based on the specific information acquired from the client apparatus, and the image processing section encrypts the image by the encryption key. The communication section transmits the encrypted image to the client apparatus. The client apparatus generates an encryption key based on the specific information determined by itself to decrypt the image.

When the client apparatus has accessed to the URI before, the image communication apparatus transmits the encrypted image without requesting input of specific information. The client apparatus provides specific information at the time of accessing to the URI. Hence, by confirming the client apparatus, the image communication apparatus is able to use specific information acquired before.

Upon access from the client apparatus, when a fixed time has elapsed after previous access, the image communication apparatus requests the input of the specific information from the client apparatus. In this way, by causing to reinput the specific information, it is possible to prevent unauthorized leakage of an image due to leakage of specific information.

When the client apparatus has accessed to the URI before, the image communication apparatus requests the input of the specific information from the client apparatus, and compares the previously acquired specific information with currently acquired specific information to determine transmission of the image.

That is, when the previous specific information matches the current specific information, the image communication apparatus transmits the encrypted image. When the previous specific information does not match the current specific information, the image communication apparatus issues a warning. The client apparatus displays a warning of input error. Alternatively, the image communication apparatus transmits a warning image to the client apparatus.

In this way, by checking specific information input by the client apparatus accessing, it is possible to prevent that a third party accesses to the image communication apparatus by spoofing so as to obtain an image.

The image communication apparatus registers acquired specific information, and when specific information input from the client apparatus matches the registered specific information, requesting reinput from the client apparatus. When a different image is transmitted to the client apparatus, each image has different URI. The client apparatus accesses to a URI of each image and provides specific information. At this time, when the same specific information is provided, there is a risk of causing a problem of the security. Hence, in order to prevent the problem, the image communication apparatus requests the client apparatus to provide different specific information. When the client apparatus provides different specific information, each image is encrypted based on different specific information.

When access frequency of the client apparatus exceeds a prescribed frequency, the image communication apparatus issues a warning. Alternatively, the image communication apparatus discards specific information of the client apparatus and requests input of new specific information from the client apparatus. In this way, by performing access restriction, it is possible to prevent unauthorized access by a third party.

As specific information, a file saved in the client apparatus is used, and the image communication apparatus generates an encryption key based on the acquired file to encrypt an image by the encryption key. The file is present only in the client apparatus and can be the specific information. In addition, the file is managed by the client apparatus and is easily used by the user.

The client apparatus generates the encryption key based on the provided file, and decrypts the image by the encryption key. The encryption key for the encryption and the encryption key for the decryption are the same, which is so-called a common key.

The image communication apparatus generates the encryption key by combining specific information and image information about an image. The image information includes data of an image itself and a URI allocated for each image.

The image communication apparatus transmits the encryption key to the client apparatus, and the client apparatus decrypts the image by the received encryption key. In this case, there is no need of generating the encryption key in the client apparatus.

The image communication apparatus has a web page to generate an encryption key, and the client apparatus displays a web page including the encryption key. That is, when the client apparatus inputs specific information in the web page, the image communication apparatus generates an encryption key based on the specific information, inserts the encryption key into the web page, and transmits the web page to the client apparatus.

According to the present invention, it is possible to use specific information determined in the client apparatus for encrypting an image, and it is not a given one, the management of the specific information can be carried out easily. Thereby, when an encrypted image is received, processing for the encrypted image can be performed reliably and an image can be obtained securely.

### BRIEF DESCRIPTION OF THE DRAWINGS

FIG. 1 is a view showing the schematic structure of an image communication system of the present invention;

FIG. 2 is a flowchart when an image is transmitted from an image communication apparatus to a client apparatus;

FIG. 3 is a view showing description contents of an electronic mail to be transmitted to the client apparatus;

FIG. 4 is a view showing a screen for a password input request;

FIG. 5 is a view showing a selection screen when a file of an image is received;

FIG. 6 is a view showing a display screen in the case of password error;

FIG. 7 is a flowchart when an image is transmitted in a case where access is performed a plurality of times;

FIG. 8 is a flowchart when an input password is confirmed;

FIG. 9 is a view showing a warning image when a password is invalid;

FIG. 10 is a flowchart when a registered password is confirmed;

FIG. 11 is a view showing a screen for a request to input another password;

FIG. 12 is a flowchart at the time of access restriction;

FIG. 13 is a view showing a warning image for excessive access;

FIG. 14 is a flowchart when an encrypted image is transmitted based on a file;

FIG. 15 is a view showing a screen for a request to input an encryption key file;

FIG. 16 is a view showing a screen for notifying an encryption key;

FIG. 17 is a flowchart when an encryption key is generated using the image communication apparatus;

FIG. 18 is a view showing a screen for a request to input an encryption key file; and

FIG. 19 is a view showing a screen for a request to input another encryption key file.

### DETAILED DESCRIPTION OF THE PREFERRED EMBODIMENTS

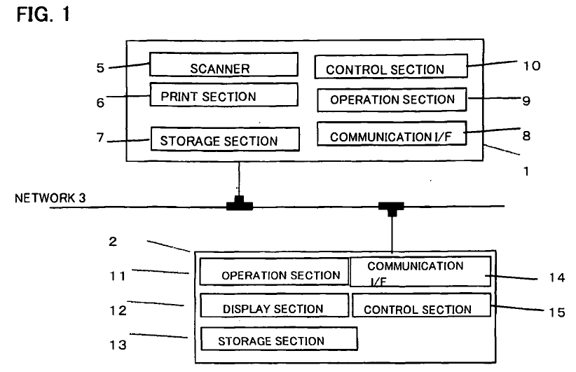

FIG. 1 shows an image communication system of the present embodiment. The image communication system is formed such that an image communication apparatus 1 and a client apparatus 2 are connected through a network 3. The image communication apparatus 1 is a multifunctional peripheral which executes copy, print, scan, FAX communication, and document filing, and the client apparatus 2 is a personal computer. The network 3 is a LAN, a WAN, or further an internet.

The image communication apparatus 1 is provided with a scanner 5 for reading an image of a document, a print section 6 for printing an image, a storage section 7 such as a hard disc device and a nonvolatile memory for storing images and various kinds of information, a communication interface 8 for communicating through the network 3 in accordance with a predetermined communication protocol such as a TCP/IP, an operation section 9 for displaying an operation screen to input an instruction from a user, and a control section 10 composed of a microcomputer for controlling a whole of the apparatus.

The client apparatus 2 is a general computer provided with an operation section 11, a display section 12, a storage section 13, a communication interface 14, and a control section 15, and is capable of communicating with the image communication apparatus 1.

The image communication apparatus 1 is provided with a web server software. The control section 10 executes the software so that the image communication apparatus 1 functions as a web server. The client apparatus 2 is provided with a browser. The control section 15 starts the browser to exchange web pages with the web server software of the web server. In this way, the image communication apparatus 1 and the client apparatus 2 form a server/client system. Moreover, the image communication apparatus 1 and the client apparatus 2 are provided with a mail software, respectively, and perform transmission/reception of an electronic mail through the network 3.

The image communication apparatus 1 transmits an input image to the client apparatus 2. That is, the image communication apparatus 1 executes network scanning in which the image read by the scanner 5 is transmitted to the specified client apparatus 2.

In the network scanning, the image communication apparatus 1 transmits a URI of the image to be transmitted to the client apparatus 2 by an electronic mail. When the client apparatus 2 accesses to the URI, the image communication apparatus 1 requests the client apparatus 2 to input specific information. The client apparatus 2 provides the image communication apparatus 1 with the specific information for encryption. The image communication apparatus 1 encrypts the image based on the specific information and transmits the encrypted image.

In order to perform this processing, the control section 10 of the image communication apparatus 1 is provided with a saving section for allocating a URI (Uniform Resource Identifier) to a file of the read image and saving the file in the storage section 7, a mail creation section for creating an electronic mail in which the URI of the image to be transmitted is described, an acquiring section for acquiring specific information from the client apparatus 2 which has accessed to the URI, an image processing section for encrypting the image based on the acquired specific information, and a communication section for performing communication with the client apparatus 2. Here, the specific information is provided as a password which has been set in the client apparatus 2, and the password is made of character information. The image processing section encrypts the image by a predetermined encrypting system using the password. The communication section transmits the encrypted image depending on a request from the client apparatus 2.

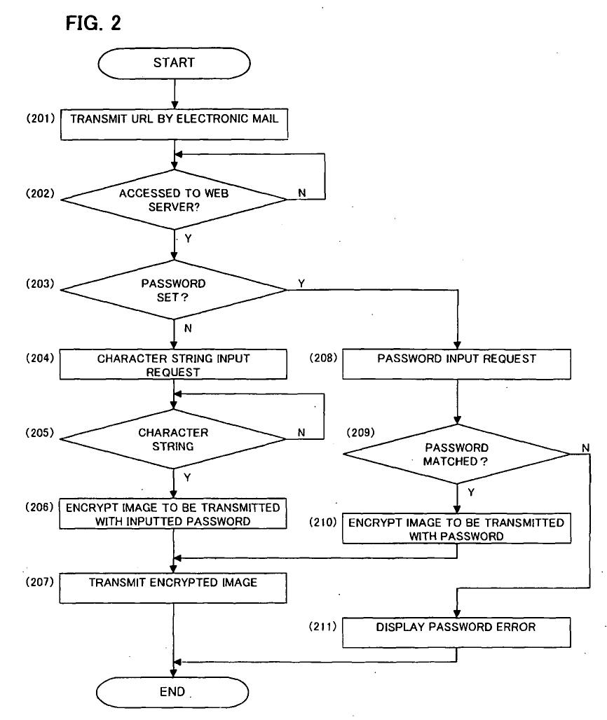

An operation at the time of performing network scanning will be described in accordance with FIG. 2. First, in the image communication apparatus 1, a user sets a document on the scanner 5 and specifies a destination client apparatus 2. The scanner 5 reads an image of the document, and the saving section of the control section 10 stores the image in the storage section 7.

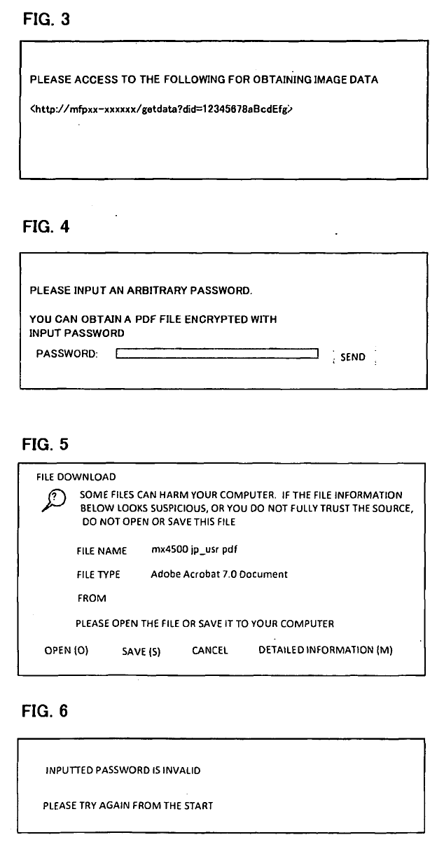

The mail creation section creates an electronic mail whose destination is a mail address of the specified client apparatus 2. The mail creation section inserts, as shown in FIG. 3, a hyperlink of a URL of the image as a URI into the body text of the electronic mail. The communication section transmits the electronic mail through the communication interface 8 to the specified client apparatus 2 (201). Note that, a URN may be used instead of the URL.

The client apparatus 2 receives the electronic mail. When the user opens the electronic mail, the URL is displayed on a screen of the display section 12. When the user clicks the URL, the control section 15 actuates a browser to access to the URL.

The control section 10 of the image communication apparatus 1 checks whether or not web server software is accessed (202). When being accessed, the control section 10 confirms whether or not a password for the URL has been set (203). That is, it is confirmed that whether or not the URL has been accessed by the client apparatus 2 before and a password from the client apparatus 2 has been set. For example, presence/absence of the access is confirmed by using a cookie which is exchanged between a server and a browser. The control section 10 registers the acquired password in a management table in association with the client apparatus 2. The management table is saved in the storage section 7. The control section 10 confirms whether or not the password of the client apparatus 2 performing access is registered by referring to the management table.

When the password is not set, that is, when the password is a new one which is not registered, the acquiring section of the control section 10 transmits a web page to request input of an arbitrary password to the client apparatus 2 (204). In the client apparatus 2, an input request screen as shown in FIG. 4 is displayed on the display section 12. When the user inputs a password made of arbitrary characters and operates a send button, the control section 15 transmits the password.

When the acquiring section of the image communication apparatus 1 receives the password (205), the password is saved and registered in the storage section 7 together with information of the client apparatus 2. The image processing section encrypts the image to be transmitted with the password as an encryption key (206) and creates a PDF file of the encrypted image. The created file is saved in the storage section 7. The communication section transmits a web page to receive the image to the client apparatus 2.

The control section 15 of the client apparatus 2 displays a dialogue for file download as shown in FIG. 5 on the screen. When the user operates a save button, the control section 15 transmits a message to request transmission of the image.

Upon reception of the message, the control section 10 of the image communication apparatus 1 reads out the file of the encrypted image from the storage section 7. The communication section transmits the file of the image to the client apparatus 2 (207).

The control section 15 of the client apparatus 2 saves the received file of the image in the storage section 13. When the file is opened, then the control section 15 requests input of the password. When the user inputs the password input for the encryption, the control section 15 decrypts the image with the password as the encryption key to display the image on the screen. Note that, instead of inputting the password, the control section 15 may save the transmitted password in the storage section 13 and read out the password when the file is opened, so that the image is automatically decrypted.

In the dialogue shown in FIG. 5, when an open button is operated, the control section 15 receives the file of the image and requests input of the password, similarly to the above. When the password is input, the image is decrypted, and the image is opened by a predetermined application to be displayed on the screen.

At step 203, when it is confirmed that the password has been set, the acquiring section of the control section 10 transmits a web page for requesting input of the password to the client apparatus 2 (208). The control section 15 of the client apparatus 2 displays an input request screen. When the user inputs the password and operates the send button, the control section 15 transmits the password.

When the acquiring section of the image communication apparatus 1 receives the password (205), whether or not the transmitted password matches a password which was acquired before (209). When the currently acquired password matches the registered password, the image processing section of the control section 10 encrypts the image to be transmitted with the password (210), and creates a PDF file of the encrypted image. Then, similarly to the above, the encrypted image is transmitted depending on a request from the client apparatus 2 (207).

The control section 10 saves the created file in the storage section 7. The communication section transmits a web page for notifying the reception of the image to the client apparatus 2.

When the currently acquired password does not match the registered password, the control section 10 transmits a web page for requesting reinput to the client apparatus 2. The control section 15 of the client apparatus 2 displays a message of error display as shown in FIG. 6 on the screen (211). Then, the client apparatus 2 performs reconnection with the image communication apparatus 1.

In this way, by providing the password determined by the user of the client apparatus 2 to the image communication apparatus 1, the user is able to use a desired password. Thus, the user is able to perform management of a password reliably and to improve convenience for the user, when compared with a case that a given password is used. In addition, since there occurs no such a case that the user forgets the password, an encrypted image can be acquired reliably.

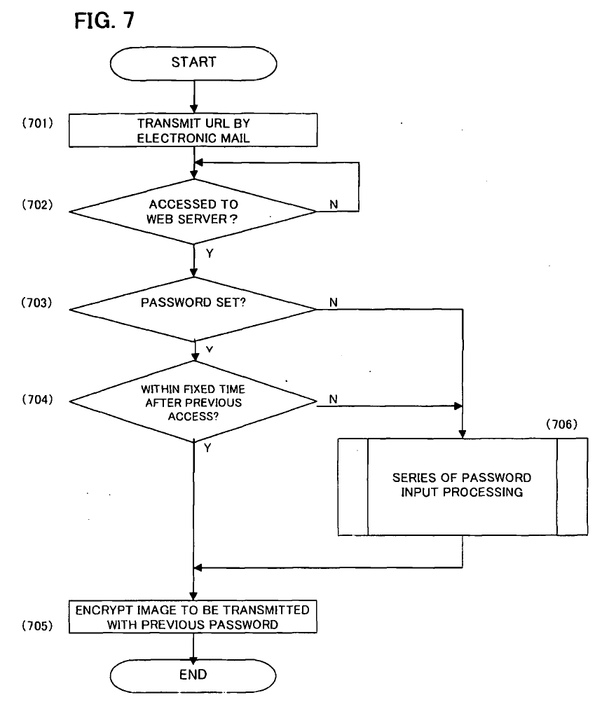

Next, there is a case that an image saved in the image communication apparatus 1 is accessed a plurality of times. In this case, the image communication apparatus 1 transmits the image using a password acquired before. As shown in FIG. 7, network scanning is executed in the image communication apparatus 1, the control section 10 transmits an electronic mail to the client apparatus 2 and waits for access from the client apparatus 2. That is, since steps 701 to 703 are the same as steps 201 to 203 in FIG. 2, description thereof will be omitted.

When it is confirmed that the password inputted from the client apparatus 2 is set, the control section 10 of the image communication apparatus 1 checks whether or not a predetermined time has elapsed after the client apparatus 2 performed access before (704). The control section 10 creates an access history and stores it in the storage section 7 when the client apparatus 2 performs access. In the access history, the time and date of the access is recorded. The control section 10 calculates the elapse of time up to the current access to determine whether or not the predetermined time has elapsed.

When the predetermined time has not elapsed, the image processing section of the control section 10 encrypts the image using the password acquired before from the client apparatus 2 (705). Then, the communication section transmits the encrypted image to the client apparatus 2.

When the predetermined time has elapsed, the control section 10 performs a series of password processing, similarly to steps 204 to 205 in FIG. 2 (706). That is, a request to input a password is made for the client apparatus 2, and the acquired password is newly registered in association with the client apparatus 2. Thereafter, the control section 10 transmits the encrypted image (705). Note that, the current password may be the same as or different from the prior one.

In this way, the prior password can be used in the case of the access within a predetermined time range, thus making it possible to save time and labor for inputting a password in the client apparatus 2. Hence, it is possible to obtain a necessary image immediately and improve the processing efficiency.

In the meantime, there is a case that unauthorized access from a third party is made to an image so as to obtain the image. Against this problem, the image communication apparatus 1 confirms an inputted password to prevent the unauthorized access.

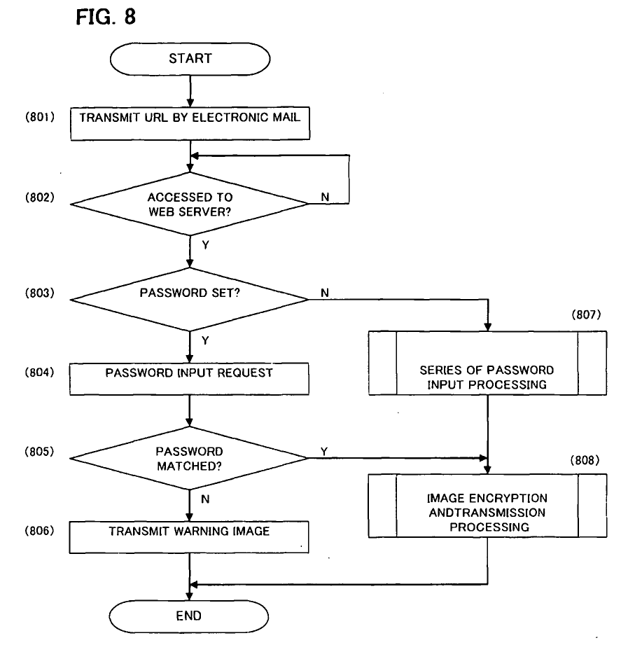

As shown in FIG. 8, steps 801 to 803 are the same as steps 201 to 203 in FIG. 2. When a password is not set, the control section 10 of the image communication apparatus 1 performs the same processing as the series of password input processing shown in step 706 of FIG. 7 (807), and similarly to steps 206 to 207 in FIG. 2, an encrypted image is transmitted to the client apparatus 2 (808).

Moreover, when the control section 10 confirms that a password inputted from the client apparatus 2 is set, the acquiring section requests the client apparatus 2 to input the password (804). When a password is input from the client apparatus 2, the control section 10 confirms that whether or not the currently acquired password matches the registered password of the client apparatus 2 (805). That is, the control section 10 collates the current password by referring to the management table.

When the current password matches the registered password, the control section 10 transmits an encrypted image to the client apparatus 2, similarly to steps 206 to 207 in FIG. 2 (808).

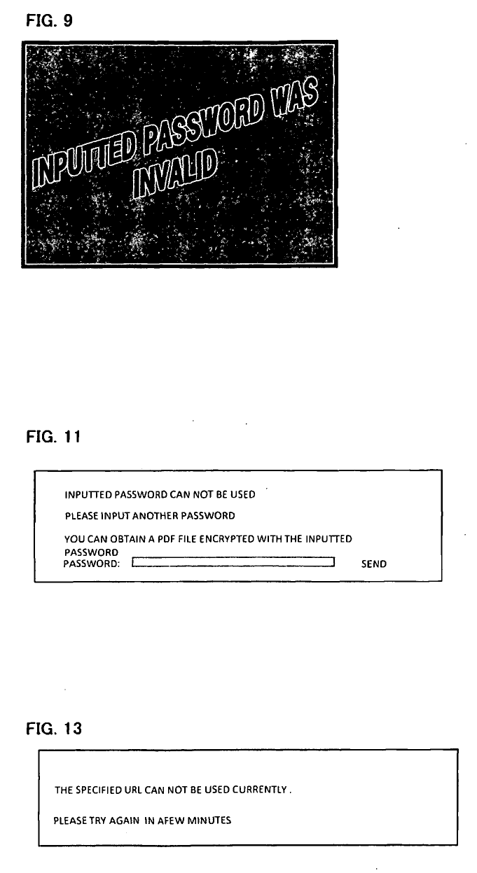

When the current password does not match the registered password, the control section 10 determines that the password is invalid, and transmits a warning image shown in FIG. 9 to the client apparatus 2 (806). The warning image is displayed on the display section 12 of the client apparatus 2.

Thereby, even when a third party tries to access to the image communication apparatus 1 through the client apparatus, it is possible to prevent the image from being transmitted by confirming the password. Hence, it is possible to prevent unauthorized image acquisition by a third party and to enhance security property.

Moreover, as described above, the image communication apparatus 1 manages passwords acquired from the client apparatuses 2 for each client apparatus 2. Alternatively, passwords may be managed for each image file. That is, the control section 10 registers input passwords for each URL of an image.

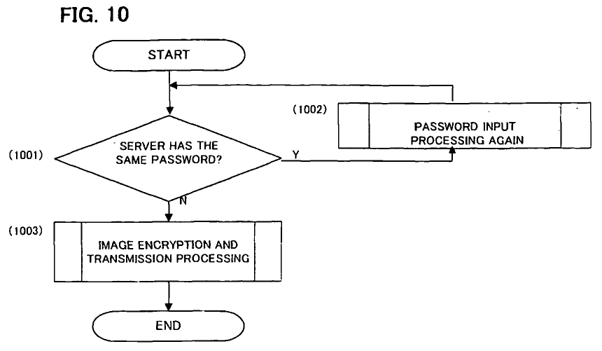

When the client apparatus 2 transmits a password in response to a request to input a password, the control section 10 of the image communication apparatus 1 confirms whether or not the password is a registered password. That is, as shown in FIG. 10, the control section 10 checks whether or not a password same as the acquired password is registered (1001). When there is no same password, the control section 10 transmits an encrypted image to the client apparatus 2, similarly to steps 206 to 207 in FIG. 2 (1002).

When there is a same password, the acquiring section of the control section 10 transmits a web page for requesting input of another password to the client apparatus 2 (1003). In the client apparatus 2, an input request screen as shown in FIG. 11 is displayed on the display section 12. When the user inputs another password made of different characters and operates the send button, the control section 15 transmits the password.

The control section 10 of the image communication apparatus 1 checks the password again and confirms that it is a new password, and then transmits an image encrypted by the password (1002). Thereafter, the control section 10 registers the new password in association with a file of the transmitted image.

In this way, by setting passwords for each file of an image, even when a password leaks, it is possible to minimize unauthorized leakage of an image.

Moreover, for security purpose, the image communication apparatus 1 limits the access frequency of the client apparatus 2. That is, the control section 10 of the image communication apparatus 1 determines whether or not the access frequency exceeds a prescribed frequency.

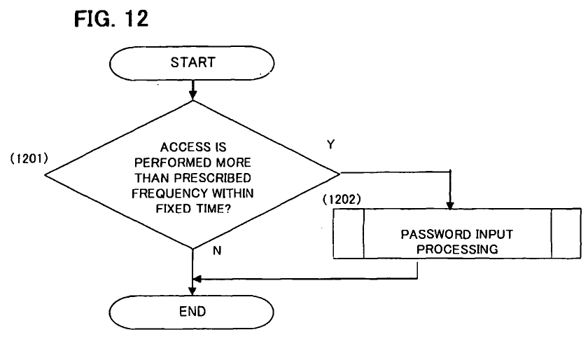

As shown in FIG. 12, the control section 10 counts the access frequency of the client apparatus 2 with respect to single image file and determines whether or not exceeding the prescribed frequency (1201). When access within a prescribed time does not exceed the prescribed frequency, the control section 10 transmits an encrypted image to the client apparatus 2.

When access is performed more than prescribed frequency within a fixed time, the control section 10 determines that it exceeds the prescribed frequency. The control section 10 discards the password registered for the client apparatus 2. Then, the control section 10 performs a request to input a password again (1202), and registers the newly acquired password.

For example, as shown in FIG. 7, when access is performed within a fixed time, an image is transmitted without requesting input of a password. In this case, there is a risk that abnormal processing is performed. Hence, when access is frequently performed, undesired leakage of an image can be prevented by changing the password.

Alternatively, when access is performed more than prescribed frequency within a fixed time, the control section 10 transmits a web page in which a warning that the access can not be performed is indicated to the client apparatus 2. In the client apparatus 2, a warning screen with respect to excess access, as shown in FIG. 13, is displayed on the display section 12. Thereby, the client apparatus can not access to the image communication apparatus.

For example, the image communication apparatus 1 confirms a password of the client apparatus 2 performing access, and when the password is not matched, the client apparatus 2 performs access again. When a third party performs unauthorized access, the authentication of the password fails, and therefore the access frequency increases. Hence, by preventing from being accessed when access is frequently performed, unauthorized image acquisition can be prevented.

An expiration date may be set for a password itself. That is, an expiration date is set when a password is registered. When a password is inputted from the client apparatus 2, the control section 10 checks whether or not the expiration date thereof expires. When the expiration date expires at the time of the access by the client apparatus 2, the control section 10 of the image communication apparatus 1 requests reinput and registers a new password. In this way, by changing the password, even when the password is stolen, the password can not be used and leakage of an image is prevented.

In the above description, a password is used as specific information. Instead of this, a file selected from files saved in the client apparatus 2 is used. The image communication apparatus 1 generates an encryption key based on a file acquired from the client apparatus 2.

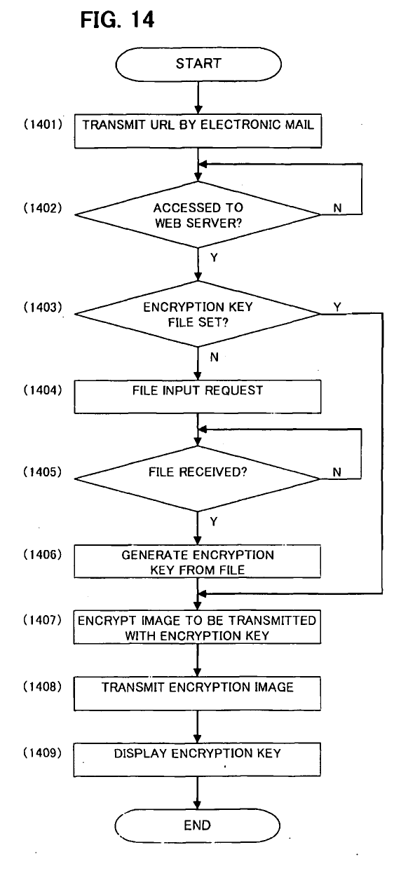

As shown in FIG. 14, when the image communication apparatus 1 executes network scanning, the mail creation section of the control section 10 creates an electronic mail whose destination is a mail address of the specified client apparatus 2. The communication section transmits the electronic mail to the specified client apparatus 2 (1401).

The client apparatus 2 accesses to a URL written in the electronic mail. The control section 10 of the image communication apparatus 1 checks whether or not web server software is accessed (1402). When being accessed, the control section 10 confirms whether or not an encryption key file of the client apparatus 2 has been set (1403).

The encryption key file is registered in the management table, similarly to a password. The control section 10 confirms whether or not the encryption key file of the client apparatus 2 performing access is registered by referring to the management table.

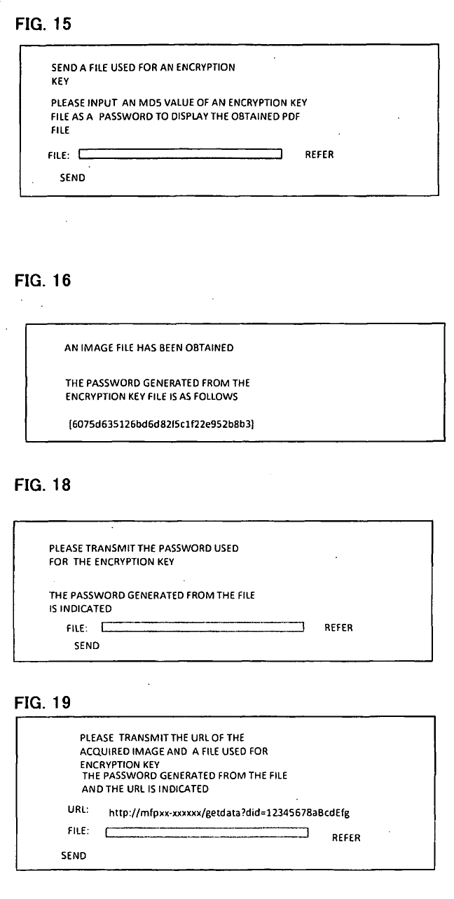

When the encryption key file is not set, the acquiring section of the control section 10 transmits a web page for requesting input of a file to the client apparatus 2 (1404). In the client apparatus 2, an input request screen as shown in FIG. 15 is displayed on the display section 12. When a user selects an arbitrary file among saved files and operates a send button, the control section 15 transmits the file.

When the acquiring section of the image communication apparatus 1 receives the file (1405), the file is registered in the management table as the encryption key file along with information of the client apparatus 2. The control section 10 generates an encryption key from the acquired file (1406). Note that, when the encryption key file is set, the control section 10 reads out the encryption key file from the management table and generates an encryption key.

Specifically, the control section 10 calculates a hash value with a fixed length by a unidirectional function such as hash function from contents of the file. As the hash function, an MD 5 (Message Digest 5), an SHA (Secure Hash Algorithm), and the like are used. The calculated hash value is provided as the encryption key.

The image processing section encrypts an image to be transmitted with the encryption key (1407), and generates a PDF file of the encrypted image. The generated file is saved in the storage section 7. The communication section transmits a web page for receiving the image to the client apparatus 2.

The control section 15 of the client apparatus 2 displays a dialogue for downloading an image file on the screen. When the user operates a save button, the control section 15 transmits a message to request transmission of the image. When the message is received, the control section 10 of the image communication apparatus 1 reads out the file of the encrypted image from the storage section 7. The communication section transmits the file of the image to the client apparatus 2 (1408).

The control section 15 of the client apparatus 2 saves the received image file in the storage section 13. Then, when the file is opened, the control section 15 decrypts the acquired file by the encryption key generated based on the file used for the encryption key.

Here, the control section 10 of the image communication apparatus 1 transmits a web page in which the generated encryption key is described to the client apparatus 2 together with the image file. The control section 15 of the client apparatus 2 displays the web page to notify the encryption key on the screen, as shown in FIG. 16 (1409).

When opening the acquired image file, input of a password is requested, and the client apparatus 2 inputs the encryption key transmitted from the image communication apparatus 1. The image is decrypted and displayed on the screen.

An encryption key may be generated in the client apparatus 2 instead of using the received encryption key. The client apparatus 2 stores a file transmitted for an encryption key and is provided with a hash tool. The hash tool is a program for calculating a hash value. With the hash tool, the control section 15 calculates a hash value and generates an encryption key based on a file.

In order to generate an encryption key, not only a file acquired from the client apparatus 2 but information about an image may be used. The image information includes a file of an image and a URL of an image. The control section 10 of the image communication apparatus 1 calculates a hash value by combining the acquired file and the image information, so as to generate an encryption key. In this case, the control section 10 transmits a web page in which the encryption key is described to the client apparatus 2. The client apparatus 2 decrypts the image using the received encryption key.

Furthermore, the client apparatus 2 is also able to generate an encryption key using the image communication apparatus 1. The image communication apparatus 1 has an application for generating an encryption key, and when a file for an encryption key is inputted, an encryption key is generated by calculating a hash value based on the file.

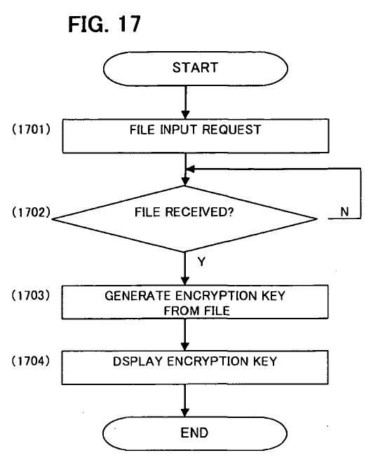

When an encrypted image is received from the image communication apparatus 1, the client apparatus 2 accesses to the application of the image communication apparatus 1. As shown in FIG. 17, the image communication apparatus 1 transmits a web page for requesting input of a file to the client apparatus 2 (1701). The control section 15 of the client apparatus 2 displays a screen to input a file as shown in FIG. 18. The client apparatus 2 transmits a selected file to the image communication apparatus 1 (1702).

The control section 10 of the image communication apparatus 1 generates an encryption key, similarly to the above, based on the acquired file (1703). The control section 10 transmits a web page in which the generated encryption key is described to the client apparatus 2. The control section 15 of the client apparatus 2 displays a web page in which the encryption key is described on the screen (1704). The control section 15 decrypts the image using the encryption key.

When an acquired file and the URL of an image are used for generating an encryption key, the image communication apparatus 1 generates a web page in which the URL of the image is described, as shown in FIG. 19, as the web page to request input of a file. Based on the file inputted from the web page and the URL of the image, an encryption key is generated.

In this way, by using a file saved in the client apparatus 2 to generate an encryption key, it is possible to generate a robust encryption key which is hardly decoded, compared with a password made of a character string. Therefore, even when a third party obtains an encrypted image, the image can not be decrypted, thus preventing leakage of contents of the image.

The present invention will not be limited to above described embodiments and many modifications and alterations can certainly be made to the above described embodiments within the scope of the present invention. The client apparatus may be a multifunctional peripheral. Moreover, it may be a mobile information terminal or a mobile phone capable of displaying an image thereon. Moreover, the transmission of images as described above may be performed by transmission through an internet FAX.

The specific information provided by the client apparatus may be user specific information including biometric information and ID information such as fingerprint of the user. Moreover, although the specific information such as a password and a file are determined by a user, the client apparatus may set the specific information automatically using time, random number and the like.

What is claimed is:

1. An image communication system in which an image communication apparatus transmits an image to a client apparatus through a network, wherein
the image communication apparatus transmits a URI of the image to be transmitted by an electronic mail to the client apparatus,
the client apparatus provides the image communication apparatus with specific information for encryption, and
the image communication apparatus encrypts the image based on the specific information and transmits the encrypted image.

2. The image communication system according to claim 1, wherein
when the client apparatus accesses to the URI, the image communication apparatus requests input of the specific information from the client apparatus.

3. The image communication system according to claim 2, wherein
when the client apparatus has accessed to the URI before, the image communication apparatus transmits the encrypted image without requesting the input of the specific information.

4. The image communication system according to claim 3, wherein
upon access from the client apparatus, when a fixed time has elapsed after previous access, the image communication apparatus requests the input of the specific information from the client apparatus.

5. The image communication system according to claim 2, wherein
when the client apparatus has accessed to the URI before, the image communication apparatus requests the input of the specific information, and compares the previously acquired specific information with currently acquired specific information to determine transmission of the image.

6. The image communication system according to claim 5, wherein
when the previous specific information matches the current specific information, the image communication apparatus transmits the encrypted image, and when the previous specific information does not match the current specific information, the image communication apparatus issues a warning.

7. The image communication system according to claim 5, wherein
when the previous specific information does not match the current specific information, the client apparatus displays a warning of input error.

8. The image communication system according to claim 5, wherein
when the previous specific information does not match the current specific information, the image communication apparatus transmits a warning image to the client apparatus.

9. The image communication system according to claim 2, wherein
the image communication apparatus registers acquired specific information, and when specific information input from the client apparatus matches the registered specific information, the client apparatus is requested to perform reinput.

10. The image communication system according to claim 2, wherein
when access frequency of the client apparatus exceeds a prescribed frequency, the image communication apparatus issues a warning.

11. The image communication system according to claim 2, wherein
when the access frequency of the client apparatus exceeds the prescribed frequency, the image communication apparatus discards specific information of the client apparatus and requests to input new specific information from the client apparatus.

12. The image communication system according to claim 1, wherein
as the specific information, a file saved in the client apparatus is used, and the image communication apparatus generates an encryption key based on the acquired file and encrypts the image by the encryption key.

13. The image communication system according to claim 12, wherein
the client apparatus generates the encryption key based on the provided file, and decrypts the image by the encryption key.

14. The image communication system according to claim 12, wherein
the image communication apparatus generates the encryption key by combining the specific information and image information concerning the image.

15. The image communication system according to claim 14, wherein
the image communication apparatus transmits the encryption key to the client apparatus, and the client apparatus decrypts the image by the received encryption key.

16. The image communication system according to claim 12, wherein
the image communication apparatus has a web page to generate the encryption key, and the client apparatus displays a web page including the generated encryption key.

17. An image communication apparatus for transmitting an image to a client apparatus through a network, comprising:
a mail creation section for creating an electronic mail in which a URI of the image to be transmitted is described,
an acquiring section for acquiring specific information from the client apparatus accessing to the URI,
an image processing section for encrypting the image based on the acquired specific information, and
a communication section for performing communication with the client apparatus, wherein
the communication section transmits the electronic mail to the client apparatus, as well as transmitting the encrypted image to the client apparatus.
